(19) United States
(12) Patent Application Publication
(10) Pub. No.: US 2003/0038833 A1
(43) Pub. Date: Feb. 27, 2003

(54) Method, operator module an response module for managing a network management system

(75) Inventors: Elke Hain, Birkenwerder (DE); Petra Bieber, Falkensee (DE)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 10/217,428

(22) Filed: Aug. 14, 2002

(30) Foreign Application Priority Data
Aug. 21, 2001 (EP) 01 440 280.4

(51) Int. Cl. G09G 5/00; G06F 15/173

(52) U.S. Cl. 345/736; 709/224

(57) ABSTRACT

A method for managing a network management system with management elements, which can forward event information by means of forwarding discriminators, with the aid of which the management elements and/or network elements managed by them can be managed. An operator module, which detects for a selection of management elements event information communication connections existing between them, with the aid of data on forwarding discriminators which operate the respective event information communication connections in the management element, and further graphically outputs the management elements of the selection and also the event information communication connections present between them in each case by way of map representing an event information network on a user interface of the network management system, and also a response module for this.

### BACKGROUND OF THE INVENTION

The invention is based on a priority application EP01440280.4 which is hereby incorporated by reference.

The present invention relates to a method for managing a network management system with management elements which can forward event information by means of forwarding discriminators, with the aid of which the management elements and/or network elements managed by them can be managed. The invention further relates to an operator module and also a response module for this, which in each case can be configured as a computer of a network management system or as a program module for a computer of this kind.

A telecommunication network or a data network can be managed, i.e. controlled and/or monitored, by a network management system. Each network element, which may be, for example, a computer, a switching center, a network service, or similar, of the telecommunication or data network, is managed by a management element of the network management system. The management element may be, for example, a control computer or a program module, the program code of which can be executed by a computer. An overriding management element, e.g. a central control computer, can be assigned to one or more management elements to control and monitor them. In relation to the network element(s) managed in each case, a management element can form an independent network management system. It can, for example, be a local network management system.

The management elements send one another so-called event information, which may be both uncritical event information, e.g. cyclic measured value information and critical event information, e.g. alarms, reports of faults or similar. For forwarding the respective event information so-called forwarding discriminators are provided in the management elements, for example so-called AFDs or EFDs (AFD=Alarm Forwarding Discriminator, EFD=Event Forwarding Discriminator) according to the recommendations of the International Telecommunication Union (ITU) within the scope of recommendation domains X.700.

A forwarding discriminator forwards event information of a source management element to a target management element on an event information communication connection. The forwarding discriminator can filter the event information for the target management element with the aid of pre-determined filter criteria.

Normally numerous, usually differently configured, forwarding discriminators and numerous event information communication connections are provided in a network management system. For an operator of the network management system, working, for example, on a client computer logged in to the network management system it is difficult to gain an overview of the event information communication connections between the management elements of the network management system.

### OBJECT OF THE INVENTION

The object of the invention is to improve the management of management elements of a network management system, in particular the management of forwarding discriminators assigned to them.

This object is achieved by a method for managing a network management system NMS

with management elements ME1-ME7, which can forward event information by means of forwarding discriminators F11, F12, F2, F31-F34, F4, F51, F52, with the aid of which the management elements ME1-ME7 and/or network elements N1-N4, SCP managed by them can be managed,

in which an operator module BC1, BC2, BC3 for a selection of management elements ME1-ME7 detects event information communication connections V11, V12, V2, V31-V34, V4, V51, V52 existing between them with the aid of data F31D-F34D, F51D, F52D on forwarding discriminators F11, F12, F2, F31-F34, F4, F51, F52 which operate the respective event information communication connections V11, V12, V2, V31-V34, V4, V51, V52 in the management elements ME1-ME7 and

in which the operator module BC1, BC2, BC3 graphically outputs the management elements ME1-ME7 of the selection and also the event information communication connections V11, V12, V2, V31-V34, V4, V51, V52 existing between them in each case by way of a map MAP1, MAP2, MAP3 representing an event information network on a user interface GUI1-GUI3 of the network management system NMS.

Further provided to achieve the object are

an operator module BC1, BC2, BC3 for managing a network management system NMS

with management elements ME1-ME7 which can forward event information by means of forwarding discriminators F11, F12, F2, F31-F34, F4, F51, F52, with the aid of which the management elements ME1-ME7 and/or network elements N1-N4, SCP managed by them can be managed,

with analyzers ANA for detecting event information communication connections V11, V12, V2, V31-V34, V4, V51, V52 between a selection of management elements ME1-ME7 with the aid of data on forwarding discriminators F11, F12, F2, F31-F34, F4, F51, F52 which operate the respective event information communication connections V11, V12, V2, V31-V34, V4, V51, V52 in the management elements ME1-ME7 and

with output means OUT for the graphic output of the management elements ME1-ME7 of the selection and also the event information communication connections V11, V12, V2, V31-V34, V4, V51, V52 present between them by way of a map MAP1, MAP2, MAP3 representing an event information network on a user interface GUI1-GUI3 of the network management system NMS; and

a response module BS1-BS7 for a management element ME1-ME7 of a network management system NMS,

wherein the management element ME1-ME7 can forward event information by means of at least one forwarding discriminator F11, F12, F2, F31-F34, F4, F51, F52, with the aid of which the management element ME1-ME7 and/or

at least one network element N1-N4, SCP managed by it can be managed, characterized by

response means ANS, configured to cooperate with an operator module BC1, BC2, BC3 and to send data on the at least one forwarding discriminator F11, F12, F2, F31-F34, F4, F51, F52 which operates at least one event information communication connection V11, V12, V2, V31-V34, V4, V51, V52 in the management element ME1-ME7, to the operator module BC1, BC2, BC3.

A basic concept of the invention is that an operator module of the network management system detects, at least for a selection of management elements, event information communication connections existing between them with the aid of data on forwarding discriminators which operate the respective communication connections in the management elements. The data are, for example, the kind of respective forwarding discriminator, e.g. AFD or EFD, its status, e.g. in service/out of service and the target or targets to which the forwarding discriminator forwards event information. The operator module graphically outputs the management elements of the selection and also the event information communication connections present between them as a kind of map on a user interface of the network management system, wherein the map, as it were, represents the event information network. The map can, for example, be configured according to a predefined model of the operator module and/or be dynamically generated.

The operator of the user interface in this way quickly and conveniently gains an overview of the event information communication connections between the management elements.

Advantageous configurations of the invention emerge from the dependent claims and from the description.

The operator module visualizes for one or more event information communication connections advantageously at least one item of information relating to the forwarding discriminator involved in the respective connection on the map. Expediently the graphic symbol representing the event information communication connection in each case is also modified. For example, the symbol can be a different color, for example, red or green, depending on whether it stands for the forwarding of critical or uncritical event information.

A preferred variant of the invention provides that one or more communication connections between two management elements, operated by one or more AFDs, are represented on the map in each case by a thick and/or red line and one or more communication connections operated by one or more EFDs are represented in each case by a thin and/or green line. Depending on whether the AFD(s) and/or EFD(s) responsible for a communication connection are unlocked or locked, the lines are, for example, continuous or dotted.

The operator module outputs the management elements expediently as symbols for event information network nodes. Communication connections between these are advantageously output as lines. By means of lines configured like arrows, e.g. lines with an arrow head or with two arrow heads, the forwarding direction for the event information forwarded on a communication connection can be visualized.

In the map representing an event information network advantageously substantially graphic symbols are used. However, alphanumeric characters can also be entered into these, for example the names of the management elements represented. Expediently it is provided that the data on the forwarding discriminators of the management elements are also output at least partially in alphanumeric characters. Advantageously a tabular form or list form is suitable for this. The data of the forwarding discriminators of a management element, for example, can be indicated in a list or table of this kind.

Based on the map generated by the operator module the data assigned to a forwarding discriminator can expediently be modified. The previously mentioned tables or lists are therein output, for example, in editable form, so an operator can modify the data of a discriminator. It is also conceivable, though, for a separate modification program to be started to modify data of the forwarding discriminators from the map generated by the operator module.

In principle the management elements and also the communication connections existing between them can be represented on the map in any form. For example, a representation can be chosen in which as few communication connections as possible cross one another. The operator module herein preferably has a routing function, e.g. in the way known from layout programs for electronic boards.

Advantageously, however, it is provided that the management elements are output in a hierarchical representation and/or in a functional representation. In the hierarchical representation, for example, a management hierarchy of the management elements is visualized. In the functional representation a distinction is made between event information source or target or transit element. Mixed forms between these configurations are possible. As event information source a management element is designated which forwards event information, for example, a management element to which a network element is assigned. An event information target is, for example, a central control computer of the network management system. A transit element forwards event information received from an event information source or from a further transit element to an event information target. A transit element can also simultaneously be an event information source, e.g. if it is provided for managing a network element.

Various methods are suitable for detecting the data on the forwarding discriminators:

Advantageously it is provided that the operator module requests the data on the forwarding discriminators from the management elements themselves.

Expediently a request partial module is provided for this in the operator module. Display of the map representing an event information network is undertaken by a display partial module of the operator module. The display partial module can, for example, be a program module, executed by a client computer of the network management system, and the request partial module can be a program module executed by a server of the network management system.

The selection of management elements for which the operator module detects the respective event information communication connections can be pre-defined in the operator module, e.g. in the form of configuration data and/or can be preset by an operator input, for example.

Expediently it is provided that the operator module requests names and/or addresses of the management elements of the selection from a name server of the network management system.

A response module can be provided in a management element for forwarding data on at least one forwarding discriminator of this management element. Expediently it is therein provided that the operator module is authenticated and/or identified in the response module, in order to prove its right to request the data on one or more forwarding discriminators.

The response module reports to the operator module the data on at least one forwarding discriminator of the management element to which the response module is assigned. However, it is also possible for the response module to request from further management elements the data on their respective forwarding discriminators, as it were by order of the operator module.

The operator module and the response module can be formed by individual constructional units of the network management system, for example by suitable computers. Both modules are, however, preferably configured as program modules, the program code of which can be executed by computers of the network management system.

### BRIEF DESCRIPTION OF THE DRAWINGS

The invention is explained below using several embodiment examples with the aid of the figures.

FIG. 1 shows a network management system NMS which manages a network NW and with which the method according to the invention can be carried out.

FIGS. 2 to 4 show graphic user interfaces GUI1-GUI3 on which maps according to the invention MAP1-MAP3 are illustrated.

FIG. 5 shows an operator module BC1 according to the invention.

FIGS. 6 and 7 show response modules BS3 and BS5 according to the invention.

FIG. 8 shows an operator terminal BT1 of the network management system NMS according to FIG. 1 in schematic view.

FIG. 9 shows, also in schematic view, a management element ME6 of the network management system NMS according to FIG. 1.

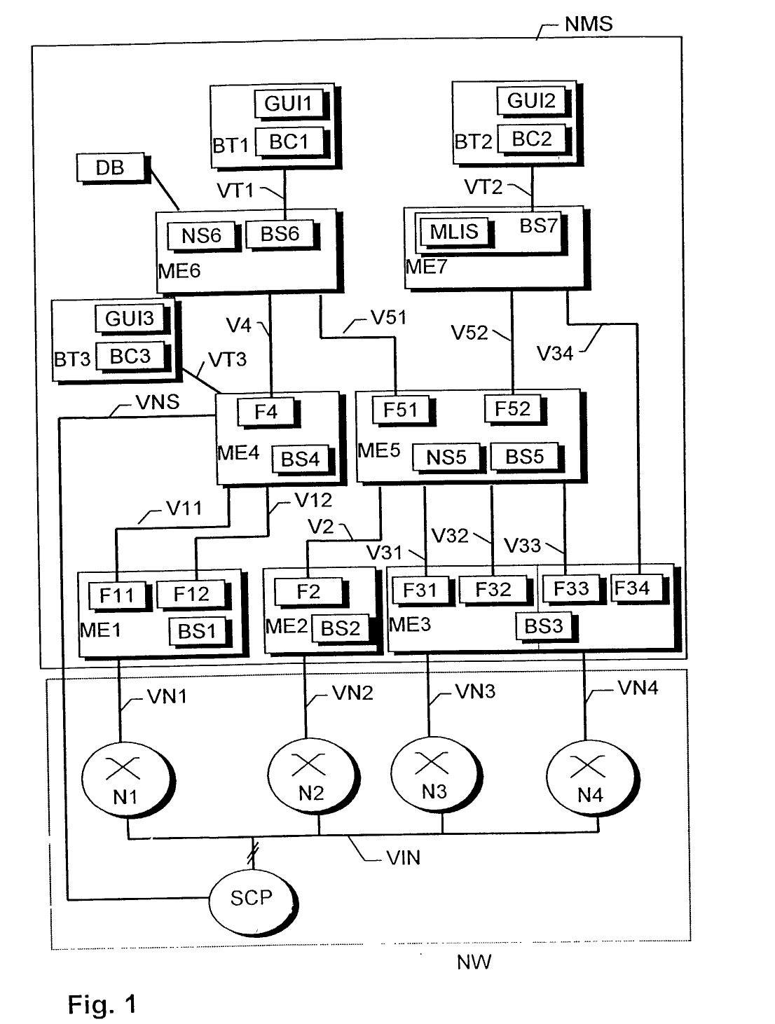

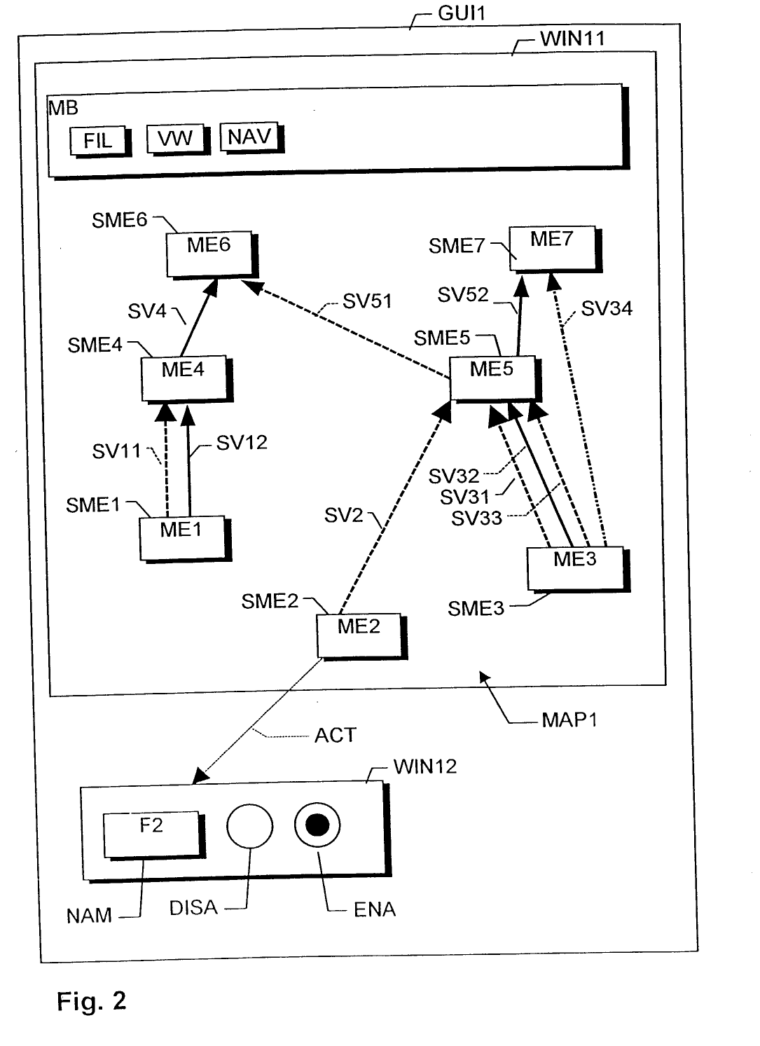

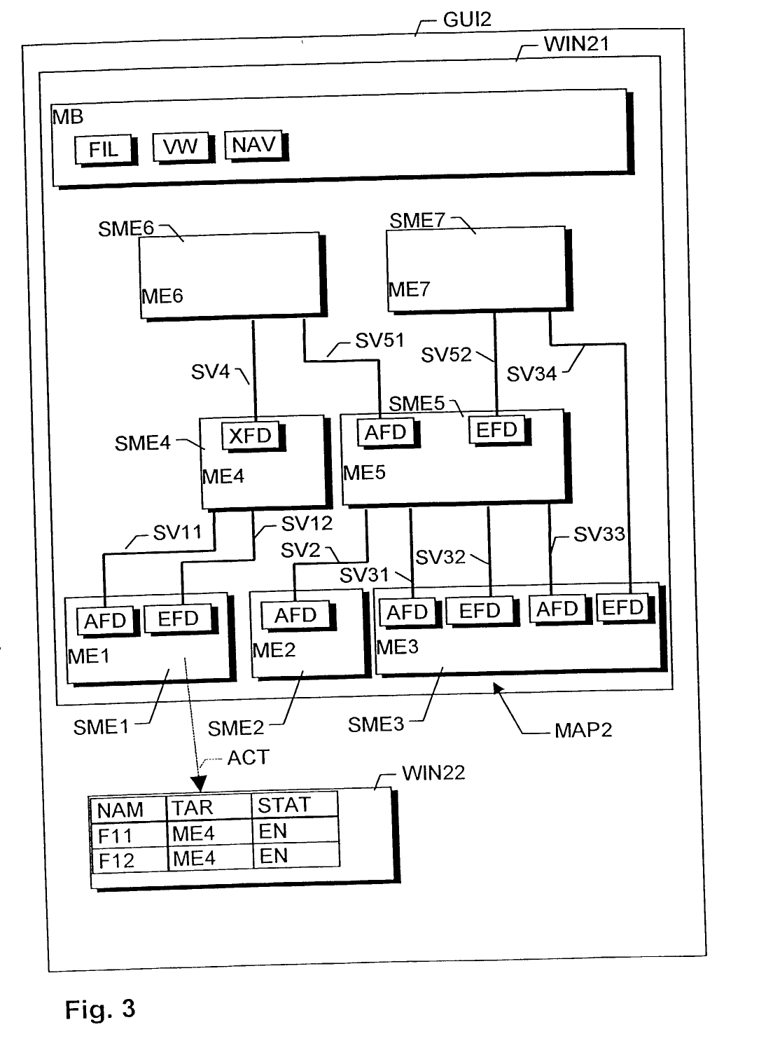

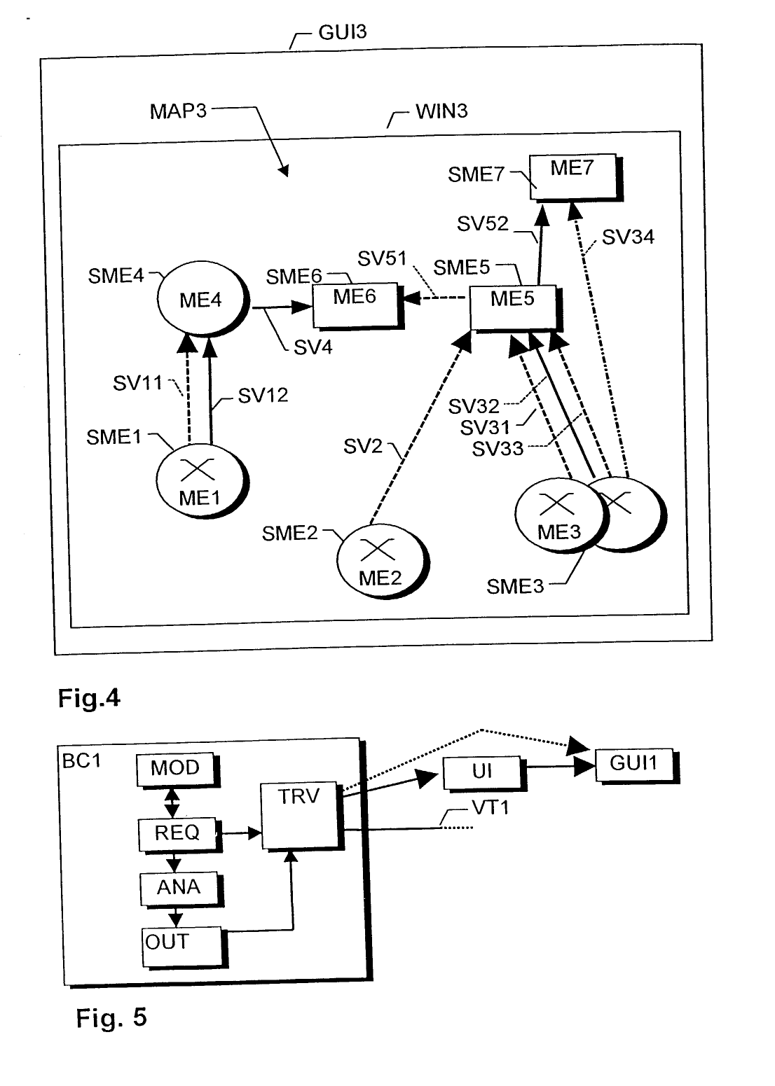

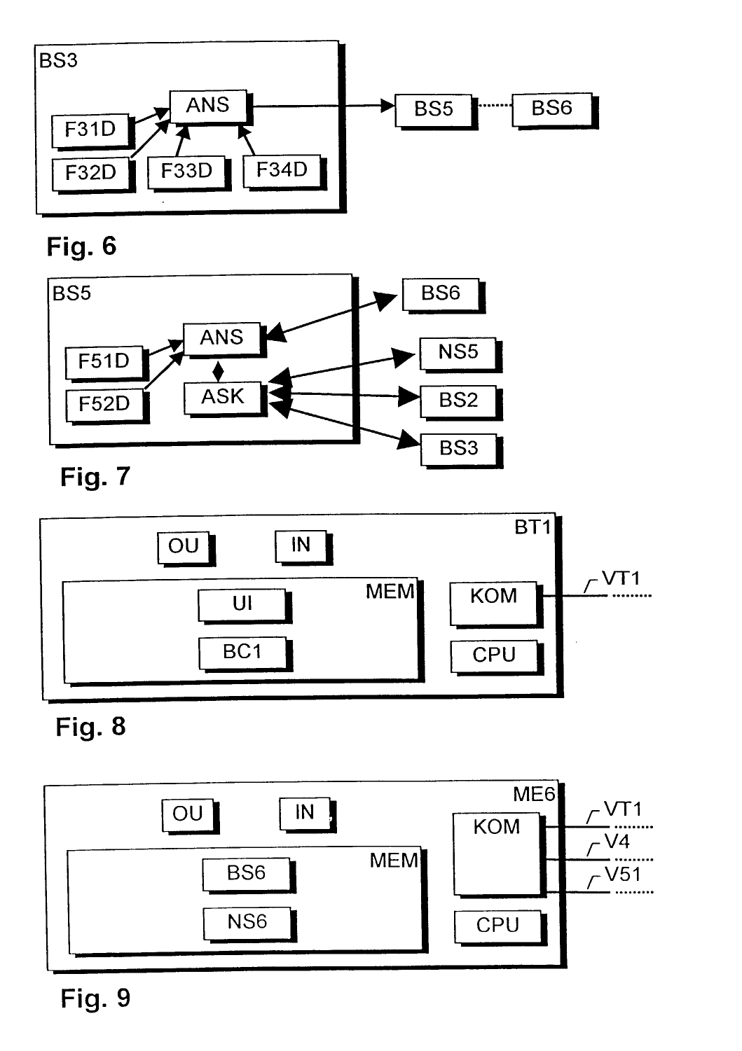

### DETAILED DESCRIPTION OF THE INVENTION

The network management system NMS serves to manage, in particular to control and monitor, the network NW, which is, for example, a computer and/or telecommunication network. In the present case the network NW is configured as a so-called intelligent network (IN) and contains network elements N1-N4, which are, for example, switching centres, and which stand as examples for further, not illustrated, network elements. To the network elements N1-N4 is assigned a central service computer SCP (Service Control Point), with the support of which the network elements N1-N4 can bring the service of a so-called intelligent network to subscriber devices, not illustrated, connected to the network NW. The service computer SCP and the network elements N1-N4 communicate via a service network VIN.

The network management system NMS, hereinafter called management system NMS for short, contains management elements ME1-ME7 and also operator terminals BT1-BT3. The management elements ME1-ME7 can be program modules, the program code of which can be executed by computers, for example servers, of the management system NMS. In the present case, however, the management elements ME1-ME7 are separate servers in each case, provided for managing one or more network elements and/or one or more management elements.

Management elements ME1 and ME2 are provided for managing network elements N1 or N2 and are connected to them via connections VN1 or VN2. Management element ME3 is provided for managing network elements N3 and N4 and connected to them via connections VN3 or VN4. Management element ME4 controls and monitors the service computer SCP via a connection VNS. Management element ME4 additionally acts as transit node or element for forwarding event information sent by management element ME1 to management element ME6. It is also possible for management element ME4 to be configured to control and/or monitor management element ME1 or network element N1.

Management element ME5 is assigned to management elements ME2 and ME3 and receives event information from them. It forwards this in a function as transit element to management elements ME6 and ME7. Management element ME5 can also be provided for control and/or monitoring of management elements ME2 and/or ME3 or network elements N2 or N3, N4 connected to them in each case.

Management elements ME6 and ME7 are central control computers of the management system NMS and are above management elements ME4 and ME5 in the hierarchy.

The management system NMS can be operated by one or more operators via the operator terminals BT1, BT2 and BT3. Operator terminals BT1-BT3 are so-called client computers, on which user interfaces GUI1, GUI2 and GUI3 are provided to operate the management system NMS. In the configuration shown operator terminal BT1 is connected to management element ME6 via a connection VT1, operator terminal BT2 to management element ME7 via a connection VT2 and operator terminal BT3 to management element ME4 via a connection VT3. At this point it should be noted that only a few of the numerous logical and physical connections of the network management system NMS are shown. Management elements ME1-ME7 and also operator terminals BT1-BT3 are connected to one another via an internal network, not shown, of the management system NMS, for example a LAN or WAN (LAN=Local Area Network, WAN=Wide Area Network).

Within the scope of its control and/or monitoring activity for network element N1 management element ME1 receives from it event reports, for example, alarms, reports of faults, load resistance measured values or similar. This event information is reported by forwarding discriminators F11 and F12 of management element ME1 to management element ME4 via connections V11 or V12. Forwarding discriminators F11 and F12 additionally exercise a filter function, i.e. they forward to management element ME4 only event information relevant to it. For this purpose filter criteria, not illustrated, are predefined in forwarding discriminators F11, F12. Forwarding discriminator F11, for example, forwards only critical event information and forwarding discriminator F12 only uncritical event information. Forwarding discriminator F11 is, for example, a so-called AFD and forwarding discriminator F12 is a so-called EFD in each case according to the definitions of the ITU.

Management element ME4 fulfils several functions: it acts as transit node for event information of management element ME1, which is to be forwarded to management element ME6. Management element ME4 further serves to control and/or monitor a network element, in the present case the service computer SCP. Moreover, management element ME1 can be controlled and/or monitored via management element ME4. For forwarding event information, for example regarding management element ME1 and/or the network element SCP, in management element ME4 forwarding discriminator F4 is provided, which forwards both critical and uncritical event information. The forwarding discriminator is, for example, a combined AFD and EFD. Operator terminal BT3 can be connected to management element ME4 for purposes of control and/or monitoring.

Management elements ME2 and ME3 send event information to management element ME5.

In management element ME2 a forwarding discriminator F2 is provided, which sends event information, in the present case alarm reports, to management element ME5 via a connection V2. Forwarding discriminator F2 is, for example, a so-called AFD.

Management element ME3 receives from network elements N3 and N4 event information in the form of event reports. For event information of network element N3 forwarding discriminators F31 and F32 are provided in management element ME3, which are, for example, an AFD or EFD and which send event information to management element ME5 via connections V31 or V32. Forwarding discriminator F31 forwards critical event information and forwarding discriminator F32 uncritical event information. For the event information of network element N4 forwarding discriminators F33 and F34 are provided in management element M3. Forwarding discriminator F33 forwards critical event information of network element N4 to management element M5 via a connection V33 and is, for example, a so-called AFD. Forwarding discriminator F34, which is, for example, a so-called EFD, forwards uncritical event information of network element N4 to management element ME7 via a connection V34.

By contrast with management element ME4, no network element to be locally controlled and/or monitored is connected to management element ME5. Management element ME5 acts exclusively as transit element for forwarding event information of management elements ME2, ME3 to management elements ME6 and ME7. In principle, though, it is also conceivable that by means of management element ME5 management elements ME2, ME3 or the network elements N2-N4 connected to them can be controlled and/or monitored. In the present case management element ME5 sends critical event information to management element ME6 by means of a forwarding discriminator F51 via a connection V51 and uncritical event information to management element ME7 via a connection V52. Forwarding discriminator F51 is, for example, an AFD and forwarding discriminator F52 an EFD.

The connections V11, V12-V52, VT1-VT3 shown inside the management system NMS are logical connections. Besides these there may also be further connections, not shown, between the management elements ME1-ME7 and the operator terminals BT1-BT3. Connections V11, V12-V52 are event information communication connections and stand, for example, for further event information communication connections, not shown, between the management elements ME1-ME7 and also further event information communication connections, not shown. To simplify, moreover, only one forwarding discriminator is shown for each communication connection in each case. In principle a forwarding discriminator can also operate several event information communication connections, however. Moreover, only a few forwarding discriminators are shown in the management elements ME1-ME7. In principle it is also possible for there to be no forwarding discriminator in a management element or any number of forwarding discriminators. In any case it is already difficult for an operator of the management system NMS with the configuration shown to gain an overview of the event information communication connections and/or of the forwarding discriminators present.

In order to make work easier for the operator in this respect, in the management system NMS operator terminals BT1-BT3 according to the invention are provided, equipped with operator modules BC1, BC2 or BC3 according to the invention. The operator modules BC1-BC3 cooperate with response modules BS1-BS7, provided in the management elements ME1-ME7. The operator modules BC1-BC3 and also the response modules BS1-BS7 are in the present case program modules, the program code of which can be executed by control means, for example, processors, of the operator terminals BT1-BT3 or by control means of the management elements ME1-ME7. In principle it is, however, also possible for the operator modules and/or the response modules to be at least partially executed in hardware and, for example, formed by the operator terminals BT1-BT3 or management elements ME1-ME7.

The operator modules BC1-BC3 receive from the management elements ME1-ME7 data on the forwarding discriminators F11, F12, F2, F31, F32, F33, F34, F4, F51 and F52 present there in each case. In principle it is in fact conceivable for the management elements ME1-ME7 to report the data on their respective forwarding discriminators spontaneously, i.e. without prior request, to the operator modules BC1-BC3 or to some other device of the management system NMS, for example a central database. With the present configuration, however, the operator modules BC1-BC3 request the respective data on forwarding discriminators present from the response modules BS1-BS7. The questions are answered by the response modules BS1-BS7. From the data on the forwarding discriminators F11-F52 communicated by the response modules BS1-BS7 the operator modules BC1, BC2 or BC3 at least partially detect the event information communication connections V11, V12, V2, V31, V32, V33, V34, V4, V51 and V52 and also the management elements ME1-ME7 involved in them in each case.

These detected data are output by operator module BC1 on a user interface GUI1 of operator terminal BT1, by operator module BC2 on a user interface GUI2 of operator terminal BT2 and by operator module BC3 on a user interface GUI3 of operator terminal BT3 in each case by way of a map MAP1, MAP2 or MAP3 representing an event information network.

Both in the requesting of the data on forwarding discriminators and in the output in map form of an event information network many variants are possible, some of which are presented below.

An operator of the management system NMS activates operator module BC1, for example, on user interface GUI1 of operator terminal BT1. For example, the operator makes an appropriate operator input on a start window of user interface GUI1, whereupon operator module BC1, for example, comes into the foreground of user interface GUI1 and/or operator terminal BT1 begins to execute the program code of operator module BC1.

Operator module BC1 sends, by request and/or connection means, for example a request function REQ, which can also be configured as a separate request partial module, or a connection function TRV, a request for detecting the forwarding discriminators present in the management system NMS to response module BS6. The request in the present case relates to all the management elements present in the management system NMS. In principle it is also possible, though, for the respective forwarding discriminators to be detected for only a selection of management elements.

It can be provided that operator terminal BT1 and/or operator module BC1 have to, as it were, log in to management element ME6 and/or to response module BS6, wherein preferably an identification and/or authentication procedure is run through.

Response module BS6 detects the management elements present in the management system NMS on request of operator module BC1. The names and/or addresses of the management elements can be stored in the response module BS6, for example in the form of configuration data. In the present case, however, the response module BS6 requests the respective data from a so-called name server NS6, which in the present case is a program module executed by management element ME6. It is further conceivable for the response module BS6 to request the names and/or addresses of the management elements of the management system NMS from a separate database, for example a database DB. In the database DB, for example, data of the management system NMS are centrally deposited and can be requested by means of its elements. Response module BS6 thereupon constructs connections to management elements ME4 and ME5 and instructs them to detect the data on the forwarding discriminators of the management elements connected to them in each case. Management element ME4 or its response module BS4 thereupon sends an appropriate request to management element ME1. A response module BS1 of management element ME1 thereupon sends the appropriate data on forwarding discriminators F11 and F12 to response module BS4. The latter sends these data and also the data on forwarding discriminator F4 of management element ME4 to response module BS6.

On request from response module BS6, a response module BS5 of management element ME5 sends data F51D and F52D relating to forwarding discriminators F51 and F52 to response module BS6 by response means ANS, for example an answering function. With the aid of a name server NS5 of management element ME5, response module BS5 further detects which management elements are connected to management element ME5. In the present case these are management elements ME2, ME3 and ME7. Correspondingly, by request means ASK, for example a request function, response module BS5 sends requests to management elements ME2, ME3 and ME7, for example to their response modules BS2, BS3 or BS7, in order to detect the data—or at least part of the data—on the forwarding discriminators present in each case in management elements ME2, ME3 or ME7.

At the appropriate request, response module BS2 sends data on forwarding discriminator F2 and, by means of response means ANS, for example a response function, response module BS3 sends data F31D, F32D, F33D, F34D, relating to forwarding discriminators F31, F32, F33 or F34. The data on forwarding discriminators, for example data F31D, include, for example, the type of forwarding discriminator, e.g. AFD or EFD, the name of the forwarding discriminator, the target to which the forwarding discriminator is sending event information, its status (disabled, enabled, locked or unlocked) or similar.

No forwarding discriminator is provided in management element ME7. Accordingly response module BS7 sends a response in which is indicated that there are no forwarding discriminators in management element ME7.

The data on forwarding discriminators received from management elements ME4 and ME5 7 is reported by response module BS6 to operator module BC1, which from these data, as it were, detects an event information network of the management system NMS.

In the previously mentioned example the requests relating to forwarding discriminators have been sent, as it were, in cascade form or in a kind of snowball system between the management elements ME1-ME7, wherein a management element in each case asks the management elements next to it and/or above and/or below it in the hierarchy about their respective forwarding discriminators. In principle it is also possible, though, and provided in a preferred variant, for an operator module and/or a response module assigned to it, for example operator module BC1 or response module BS6 of management element ME6, to request the data on the respective forwarding discriminators from management elements ME1-ME5, ME7 directly—without the cooperation of intermediately connected response modules. It is further possible for operator module BC1 to have the functionality of response module BS6. In a configuration of this kind operator module BC1 has request means with which it can request data on their respective forwarding discriminators from a selection of management elements, or optionally from all the management elements of the network management system NMS.

From the data on the forwarding discriminators the analyzers ANA of operator module BC1 detect the communication connections V11, V12-V52 between the management elements ME1-ME7 and forward the thus detected data to output means OUT, which can also be configured as a separate output partial module and which from these data generate the map MAP1 and output it on user interface GUI1 in the form of a window WIN11. If operator terminal BT1 has a so-called X-window environment, for example, window WIN11 can, for example, be generated by X-window functions of operator module BC1. It is also possible, though, for operator module BC1 to instruct a suitable user interface module, for example user interface module U1, to output the map MAP1. The user interface module U1 is, for example, a browser, suitable for output of graphic data and/or data in a so-called Markup Language, e.g. the HTML (Hypertext Markup Language). Naturally, combinations of both output forms are possible, as will become clear below. Window WIN11 is therein generated by operator module BC1 itself and window WIN12 by user interface module U1.

Window WIN11 shows the map MAP1 with graphic illustrations or symbols SME1-SME7 of the management elements ME1-ME7. Further provided in window WIN11 is a menu bar and/or button bar MB, with which various functions of operator module BC1 can be activated. For example, a menu and/or button FIL is provided, by which window WIN11 can be closed and/or the map MAP1 saved in a file. Further provided is a menu or button VW, via which various representational forms of the map MAP1 can be called up. The menu point VW can also be provided to, as it were, update the map MAP1, wherein again requests on the forwarding discriminators are sent to the management elements ME1-ME7, as already explained above. Via a menu NAV it is possible to navigate to other windows and/or applications of user interface GUI1.

For the event information communication connections V11, V12, V2, V31, V32, V33, V34, V4, V51, V52, symbols SV11, SV12, SV2, SV31, SV32, SV33, SV34, SV4, SV51 or SV52 graphically representing them are represented on the map MAP1. On the map MAP1 the symbols SV11-SV52 are lines with an arrow head representing the forwarding direction of the event information forwarded in each case. Each symbol SV11-SV52 therein symbolises in each case one forwarding discriminator F11-F52. In addition the symbols SV11-SV52 indicate the type of the respective forwarding discriminator: a continuous line stands for an EFD and a dotted line for an AFD. It is also conceivable to visualize the type of a forwarding discriminator assigned to a communication connection by different color and/or different line thickness of the symbol assigned in each case. Further, a symbol could also be animated, for example a symbol representing a communication connection based on an AFD could flash.

Further information relating to a forwarding discriminator can also be graphically elucidated on the map MAP1. For example, forwarding discriminator F34 is in a locked status in which it does not forward any event information. Corresponding to this status, symbol SV34 of communication connection V34 is a dotted line. It would also be conceivable to make the symbol SV34, standing for one or more locked and/or inactive communication connections, move optically into the background, for example by means of a representation in a relatively neutral color, e.g. gray.

For reasons of clarity of view it can be provided that each of the symbols SV11, SV12, SV2, SV31, SV32, SV33, SV34, SV4, SV51 and SV52 stands on the map MAP1 in each case for several communication connections and/or several forwarding discriminators. It is therein preferred that in each case one symbol SV11, SV12, SV2, SV31, SV32, SV33, SV34, SV4, SV51 and SV52 stands for one or more forwarding discriminators of the same type, in other words, for example, one symbol for several AFDs and one symbol for several EFDs. If in a symbol SV11, SV12, SV2, SV31, SV32, SV33, SV34, SV4, SV51 and SV52 all the assigned forwarding discriminators are in a predetermined status, for example locked, the symbol changes its appearance and is, for example, a dotted line, such as symbol SV34, for example. Even if only one of the forwarding discriminators assigned to a common symbol is not in this predetermined status, in other words, for example, is unlocked, the symbol shows this status for all the assigned forwarding discriminators. Symbol SV34 would be a continuous line, for example, if it were to represent not only the locked forwarding discriminator F34, but also a not-illustrated second forwarding discriminator sending event information to management element ME7 in the status unlocked.

Via the menu VW various views of map MAP1 can be activated, for example the present view, in which all the communication connections between the management elements ME1-ME7 are shown or two further, not-illustrated views, in which in each case either the communication connections operated by AFDs or those by EFDs are shown.

Based on window WIN11 detailed information on the forwarding discriminators of management elements ME1-ME7 can also be called up. For example, window WIN12 is activated via the menu NAV and/or by activating a symbol on the map MAP1, i.e. operating module BC1 generates window WIN12 first or window WIN12, initially standing in the background of user interface GUI1, on activation is faded into the foreground. For example, on activation ACT of symbol SME2 and/or symbol SV2, e.g. by means of a mouse click or a keyboard entry, window WIN12 is started, which outputs data on forwarding discriminator F2 of management element ME2. For example, ‘F2’ is indicated as the name NAM of forwarding discriminator F2. Further, its status of disabled or enabled is output in selection fields DISA or ENA. Selection field ENA is marked by a dot, i.e. forwarding discriminator F2 is enabled.

With operator module BC1 in the present configuration, data of forwarding discriminators can also be modified. For example, from window WIN12, started based on map MAP1, the status of forwarding discriminator F2 can be changed. For example, by means of an operator input the selection field DISA can be marked, wherein the marking in selection field ENA automatically disappears. Modification means MOD of operator terminal BC1 detect this change and send appropriate modification commands to management element ME2 via connection means TRV.

Operator module BC2 of operator terminal BT2, which can be started from user interface GUI2, shows a further variant of the invention, though it is constructed in the same way in its basic functions as the already described operator module BC1.

On operator input or cyclic updating, operator module BC1 sends a request for data on forwarding discriminators of the management system NMS to the response module BS7. With the aid of internal data MLIS, which are, for example, configuration data, response module BS7 detects the management elements present in the management system NMS and sends to them requests on their forwarding discriminators. Herein the corresponding request can also be sent in cascade form to management elements ME4 and ME5 and, based on these, forwarded to management elements ME6, ME1, ME2, ME3. It is also possible, however, for response module BS7 to send an appropriate request for data on their respective forwarding discriminators directly to management elements ME1-ME6.

From the data on their forwarding discriminators obtained from management elements ME1-ME6 operating module BC2 initially generates a window WIN21 on user interface GU12. In the same way as window WIN12 of operator module BC1, window WIN21 also contains a menu bar MB, which is approximately identically constructed to and/or functions in the same way as the menu bar MB of the same name of window WIN11. Window WIN21 further contains map MAP2, which shows a further output form for the event information network of the management system NMS. The symbols SME1-SME7 for the management elements ME1-ME7, like the symbols of the same name of map MAP1, are abstract geometric representations, which in map MAP2, however, are at least partially differently configured from those of map MAP1.

In this connection it should be mentioned that the symbols SME1-SME7 representing management elements ME1-ME7 on the respective maps MAP1, MAP2 can reproduce a function and/or a status of the management element assigned in each case by colored and/or geometric or some other visually detectable configuration.

The symbols SME1-SME7 are arranged in a hierarchical fashion on map MAP2. On map MAP2 the hierarchy at the same time reproduces the hierarchical control and monitoring function of management elements ME1-ME7. It is also possible, though, for a map to be output with a purely functional, non-hierarchical representation.

At the same time on map MAP2 the hierarchy also clarifies the direction in which event information is communicated: in the present case from the bottom to the top. Therefore symbols SV11-SV52 on map MAP2 are only simple lines, without a component clarifying the respective transmitting direction, for example the tip of an arrow. Further illustrated on map MAP2 are symbols designated with ‘AFD’, ‘EFD’ or ‘XFD’ for forwarding discriminators F11-F52 in management elements ME1-ME5. Each of the symbols ‘AFD’, ‘EFD’ or ‘XFD’ can stand in each case for one or more AFDs, EFDs or combined AFDs and EFDs. In this connection it should also be mentioned that each symbol SV11-SV52 can stand for one or more event information communication connections.

Detailed information on forwarding discriminators can also be called up from window WIN21. For example, on activation ACT of symbol SME1 window WIN22 can be started. Operator module BC2 in this case sends, for example, a table to a browser, e.g., a Netscape Navigator or a Microsoft Internet Explorer, or generates window WIN22 itself. In the table the names NAM of forwarding discriminators F11 and F22 are indicated in a first column, and also their respective target (or respective targets) for forwarding event information and their respective status. In both forwarding discriminators F11, F22 ME4 is entered as target and ‘ENA’ (=enabled) as status. Naturally, the table of window WIN22 can also contain further information, for example an application program of server ME4 as exact target and/or further status information, for example locked/unlocked and/or enabled/disabled. It is further conceivable that the data in the table of window WIN22 can be modified, i.e., for example, the name of discriminator F11 can be changed to ‘F13’. The corresponding information on changes is then forwarded by operator module BC2 to the relevant management element.

A preferred variant of the invention provides that, for example, via menu VW a window, not illustrated in the figure, is started, in which, e.g. operator module BC2 outputs a table in which data of all the forwarding discriminators present in a management element ME1-ME7 in each case or in which all the data of all the forwarding discriminators F11, F12, F2, F31-F34, F4, F51, F52 present in management elements ME1-ME7 are indicated. The respective table can be communicated by operator module BC2 for output to a browser and/or output in a self-generated representation, e.g. in a self-generated window.

Operator module BC3 of operator terminal BT3 requests data on forwarding discriminators from management elements ME1-ME7 in one of the previously mentioned ways, for example with the cooperation of response module BS4. It is also possible for operator module BC3 to request the data itself from the relevant management elements ME1-ME7. In any case operator module BC3 generates from these data map MAP3 in a window WIN3 on user interface GUI3. By comparison with maps MAP1, MAP2, in map MAP3 the symbols SME1-SME7 for the management elements ME1-ME7 are configured differently and visually reproduce at least partially the network element(s) managed by them in each case. They are to some extent capable of prediction.

Management elements ME1 and ME2 in each case manage a switching center as network element. Correspondingly symbols SME1, SME2 are represented as switching center symbols. Management element ME3 in the present case manages two switching centers as network elements, for which reason the symbol SME3 of management element ME3 indicates two switching centers. Symbol SME4 is intended to depict the service computer SCP managed by management element ME4.

The symbols SV11-SV52 for the event information communication connections V11-V52 correspond to those of map MAP1. Using map MAP3 it becomes clear that a hierarchical and/or functional representation of the management elements ME1-ME7, though expedient, is not absolutely necessary. For example, the management elements of the respective operator module can be arranged on the respective map in such a way that the communication connections between them are as free from crossover as possible.

FIG. 8 shows as an example operator terminal BT1 and FIG. 9 as an example management element ME6. Operator terminals BT2 and BT3 or management elements ME1-ME5, ME7 are functionally identically constructed to operator terminal BT1 or management element ME6. Operator terminal BT1 and management element ME6 are in principle known computers, containing, for example, control means CPU, e.g. processors or processor arrangements, memory means MEM, for example RAM memory (RAM=Random Access Memory), hard-disk drives or similar, and also input and output means IN, OI. The computers BT1, ME6 further contain communication means KOM, for example LAN interface maps or similar. The input means IN are, for example, a keyboard, a mouse, a microphone or similar. The output means OU are, for example, a monitor, a loudspeaker or similar. The control means CPU have executed program codes of program modules, in operator terminal BT1, for example, user interface module UI and also operator module BC1, which are deposited in the memory means MEM. Not illustrated in computers BT1, ME6 is in each case an operating system, for example UNIX or Windows-NT, which controls and monitors the basic functions of the respective computer BT1, ME6.

For the process communication of the program modules within the management system NMS, for example for communication of operator module BC1 with user interface module UI and/or with response module BS6 a so-called ORB architecture can be provided, for example (ORB=Object Request Broker), e.g. CORBA (Common Object Request Broker Architecture).

1. Method for managing a network management system
with management elements, which can forward event information by means of forwarding discriminators, with the aid of which the management elements and/or network elements managed by them can be managed,
in which an operator module for a selection of management elements detects event information communication connections existing between them with the aid of data on forwarding discriminators which operate the respective event information communication connections in the management elements and
in which the operator module graphically outputs the management elements of the selection and also the event information communication connections existing between them in each case by way of a map representing an event information network on a user interface of the network management system.

2. Method according to claim 1, wherein the operator module
detects, for at least one event information communication connection, at least one item of information relating to the forwarding discriminator involved in the event information communication connection and
visualizes the at least one item of information on the map, in particular by modification of a graphic symbol representing the at least one event information communication connection.

3. Method according to claim 1, wherein
the management elements of the selection are output as symbols for event information network nodes and/or
the communication connections are output as, in particular, arrow-like symbols between the symbols for the management elements.

4. Method according to claim 1, wherein the operator module outputs the data on the forwarding discriminators of the management elements of the selection at least partially in alphanumeric characters, in particular in tabular or list form.

5. Method according to claim 1, wherein the data of at least one forwarding discriminator are at least partially modifiable based on the map generated by the operator module.

6. Method according to claim 1, wherein the management elements of the selection are output in a hierarchical representation and/or in a functional representation as event information source and/or event information target and/or event information transit element.

7. Method according to claim 1, wherein the operator module requests the data on the forwarding discriminators from the management elements.

8. Method according to claim 6, wherein
a request partial module of the operator module requests the data on the forwarding discriminators from the management elements and
a display partial module of the operator module graphically outputs the management elements of the selection and also the event information communication connections present between them in each case.

9. Method according to claim 1, wherein in at least one management element a response module assigned to the operator module reports data on at least one forwarding discriminator of the management element to the operator module.

10. Method according to claim 1, wherein the operator module requests the selection of the management elements from a name server of the network management system.

11. Operator module for managing a network management system
with management elements which can forward event information by means of forwarding discriminators, with the aid of which the management elements and/or network elements managed by them can be managed,
with analyzers for detecting event information communication connections between a selection of management elements with the aid of data on forwarding discriminators which operate the respective event information communication connections in the management elements and
with output means for the graphic output of the management elements of the selection and also the event information communication connections present between them by way of a map representing an event information network on a user interface of the network management system.

12. Operator module according to claim 11, wherein it is configured as a computer, in particular as a client computer, of the network management system.

13. Response module for a management element of a network management system,
wherein the management element can forward event information by means of at least one forwarding discriminator, with the aid of which the management element and/or at least one network element managed by it can be managed,
characterized by response means, configured to cooperate with an operator module and to send data on the at least one forwarding discriminator which operates at least one event information communication connection in the management element, to the operator module.

14. Operator module according to claim 11, wherein it contains a program code which can be executed by a control means of a computer, in particular a client computer or a server computer of the network management system.

15. Response module according to claim 13, wherein it contains a program code which can be executed by a control means of a computer, in particular a client computer or a server computer of the network management system

16. Network management system or computer of a network management system with at least one operator module according to claim 11 or 14 and/or at least one response module according to claim 13 or 15.

17. Memory means, in particular diskette or CD-Rom, Digital Versatile Disc, hard-disk drive or similar, with an operator module according to claim 14 stored on it and/or with a response module according to claim 15 stored on it.

18. Computer readable memory means, in particular diskette or CD-Rom, Digital Versatile Disc, hard-disk drive or similar, with an operator module stored on it for managing a network management system with management elements which can forward event information by means of forwarding discriminators, with the aid of which the management elements and/or network elements managed by them can be managed, wherein the operator module contains a program code which can be executed by a control means of a computer, in particular a client computer or a server computer, of the network management system, wherein the computer performs the following functions:
detecting event information communication connections between a selection of management elements with the aid of data on forwarding discriminators which operate the respective event information communication connections in the management elements and
graphic output of the management elements of the selection and also the event information communication connections present between them by way of a map representing an event information network on a user interface of the network management system.

19. Computer-readable memory means, in particular diskette or CD-Rom, Digital Versatile Disc, hard-disk drive or similar, with a response module stored on it for a management element of a network management system,
wherein the management element can forward event information by means of at least one forwarding discriminator, with the aid of which the management element and/or at least one network element managed by it can be managed,
wherein the response module contains a program code which can be executed by a control means of a computer, in particular a client computer or a server computer, of the network management system,
wherein the computer performs the function of sending data on the at least one forwarding discriminator which operates at least one event information communication connection in the management element, to an operator module according to claim 11.
